(19) United States
(12) Patent Application Publication
(10) Pub. No.: US 2026/0244459 A1
(43) Pub. Date: Aug. 20, 2026

(54) SYSTEM AND METHOD FOR HARDWARE ACCELERATION AND OPTIMIZATION OF KRUM ALGORITHM IN FEDERATED LEARNING

(71) Applicant: QUAN CHENG LABORATORY, Jinan (CN)

(72) Inventors: Chuan ZHAO, Jinan (CN); Fanxing KONG, Jinan (CN); Shan JING, Jinan (CN); Shengnan ZHAO, Jinan (CN); Zhenxiang CHEN, Jinan (CN); Lei JU, Jinan (CN)

(73) Assignee: QUAN CHENG LABORATORY, Jinan (CN)

(21) Appl. No.: 19/540,614

(22) Filed: Feb. 14, 2026

(30) Foreign Application Priority Data
Feb. 14, 2025 (CN) 202510163854.X

(51) Int. Cl. G06F 9/448; G06F 5/06; G06F 18/22

(52) U.S. Cl. CPC G06F 9/4498; G06F 5/06; G06F 18/22

(57) ABSTRACT

Disclosed is a system and method for hardware acceleration and optimization of a Krum algorithm in federated learning. The system includes: a data control module, a data First In First Out (FIFO) module, and an algorithm computing module. The data control module, the data FIFO module, and the algorithm computing module are sequentially connected, and the data control module is connected to the algorithm computing module. The data control module is configured to perform pipeline control of the Krum algorithm; the data FIFO module is configured to cache a model gradient parameter of a client and perform cyclic reading; and the algorithm computing module is configured to compute the Krum algorithm, including Euclidean distance calculation and minimum gradient calculation. Each module is independent and has clear functions and is responsible for specific tasks, respectively, thereby improving maintainability, scalability, and flexibility of performance optimization of the algorithm.

### CROSS-REFERENCE TO RELATED APPLICATIONS

This application claims priority to Chinese Patent Application No. 202510163854.X, filed on Feb. 14, 2025, the contents of which are hereby incorporated by reference.

### TECHNICAL FIELD

The present disclosure relates to the field of federated learning and hardware acceleration, and in particular, to a system and a method for hardware acceleration and optimization of a Krum algorithm in federated learning.

### BACKGROUND

With increasing demands for data privacy protection, federated learning, as a distributed machine learning framework, has gradually gained widespread attention and application. Federated learning allows a plurality of participants to train respective local data and share only model parameter updates to construct a global model. This manner not only effectively reduces risks of data leakage and privacy exposure but also alleviates the problem of data silos to some extent. However, in practical applications, an open environment of federated learning introduces new security and stability challenges, especially threats from malicious participants.

In a federated learning scenario, a trust foundation among participants is typically weak, and there is a possibility that individual malicious participants may interfere with model training in various ways. Byzantine attacks are a common and severe threat. The malicious participants may manipulate an optimization process of the global model by uploading maliciously designed model updates. These attacks may manifest as uploading random noise, forged gradients deviating from a global objective, or even carefully designed adversarial updates. The purpose of these attacks may be to disrupt convergence of the global model, resulting in the failure of model training.

To counter the Byzantine attacks, the Krum algorithm, as a robust aggregation algorithm, has been proposed and widely applied in the federated learning. The Krum algorithm calculates Euclidean distances between a model uploaded by each participant and models of other participants, and selects a model update that is closest to other model updates as an update result of the global model, thereby effectively identifying and excluding malicious participants whose model updates deviate significantly from most model updates. In this way, the Krum algorithm can significantly improve robustness and stability of a federated learning system in case of the Byzantine attacks, avoid interference from malicious updates to the global model, and ensure that the model can converge normally under adverse conditions.

However, high efficiency and robustness of the Krum algorithm also bring computational challenges. Since the algorithm needs to calculate Euclidean distances between a model uploaded by each participant and all other models, this process typically involves a large amount of matrix operations and distance calculations. Especially when a count of participants is large, the computational complexity of the Krum algorithm increases exponentially, leading to a significant increase in required computational resources and time. For example, when the count of participants reaches hundreds or thousands, the algorithm needs to perform tens of thousands of distance calculations, and each calculation needs to process large-scale model parameters, which drastically extends execution time of the algorithm.

Therefore, although the Krum algorithm is capable of theoretically effectively countering the Byzantine attacks, the performance bottleneck of the Krum algorithm in practical applications becomes a major challenge for the federated learning system. When executing the Krum algorithm on a traditional central processing unit (CPU), due to a lack of sufficient parallel computing capability, the calculation speed becomes relatively slow, seriously affecting efficiency of the entire federated learning process. The computational bottleneck limits promotion and deployment of the Krum algorithm in practical applications, especially in systems requiring high throughput and real-time performance, where performance issues are more prominent. Therefore, how to achieve efficient Krum algorithm computation and significantly improve computational performance of the Krum algorithm becomes a key problem that urgently needs to be addressed in the current research on federated learning.

Hardware acceleration technology, especially field programmable gate arrays (FPGAs), has been widely used in the field of high-performance computing due to its excellent parallel computing capability and high customizability. However, the current research on hardware acceleration for the Krum algorithm is still relatively scarce. Existing solutions mainly focus on software-level optimization, and fail to fully leverage the computing performance advantages of hardware. Accordingly, developing an implementation method of the Krum algorithm based on hardware acceleration can accelerate algorithm execution speed and improve the overall efficiency and reliability of the federated learning system.

Therefore, it is desirable to provide a system and a method for hardware acceleration and optimization of a Krum algorithm in federated learning.

### SUMMARY

One or more embodiments of the present disclosure provide a system for hardware acceleration and optimization of a Krum algorithm in federated learning. The system includes a data control module, a data First In First Out (FIFO) module, and an algorithm computing module. The data control module, the data FIFO module, and the algorithm computing module are sequentially connected, and the data control module is connected to the algorithm computing module. The data control module is configured to perform pipeline control of the Krum algorithm; the data FIFO module is configured to cache a model gradient parameter of a client and perform cyclic reading; the algorithm computing module is configured to compute the Krum algorithm, including Euclidean distance calculation and minimum gradient calculation. The data control module is used for orderly pipeline control of data and supports backpressure calculation. The orderly pipeline control of data is implemented by a finite state machine (FSM). A state transition condition is dynamically adjusted according to an input data volume (in_sum) and a count of arithmetic logic units (ALU_MEM). Each state includes a pipeline pressure enable (ppen) signal trigger condition for controlling data flow and backpressure. After receiving a start signal (start), the data control module drives a transition of a processing stage of data through FSM, and precisely tracks progress of the data in a plurality of processing stages through a counter; the data control module generates, according to a current processing stage of the data, a ppen signal and transmits the ppen signal to the algorithm computing module to control orderly flow of the data among buffering, processing, and clearing stages, thereby achieving efficient data transmission.

One or more embodiments of the present disclosure provide a method for hardware acceleration and optimization of a Krum algorithm in federated learning. The method includes: controlling a data pipelined operation, comprising implementing pipelined control of data through an FSM; caching data of a participant and reading the data of the participant multiple times; performing Krum algorithm computation by reading a parameter from an FIFO buffer and a parameter of another participant from a memory, comprising: first performing an addition operation and a multiplication operation for calculating a Euclidean distance between gradients of two participants; then performing a square root operation on an output sum of squares result to obtain a true Euclidean distance between the two participants; finally selecting smallest n−f−1 valid values from Euclidean distances calculated from a plurality of participants, summing the selected smallest n−f−1 valid values to calculate a valid distance sum, and feeding back the valid distance sum to a front end; dynamically adjusting a state transition condition according to an in_sum and an ALU_MEM; providing a ppen signal trigger condition in each state for controlling data flow and backpressure; and after receiving a start, driving, by the FSM, a transition of a processing stage of data, and precisely tracking progress of the data in a plurality of processing stages through a counter; and generating a ppen signal and transmitting the ppen signal to an algorithm computing module according to a current processing stage of the data to control orderly flow of the data among buffering, processing, and clearing stages, thereby achieving efficient data transmission.

The beneficial effects of the embodiments of the present disclosure include, but are not limited to the following content:

According to the embodiments of the present disclosure, hardware implementation of the Krum algorithm in federated learning against Byzantine attacks is implemented. The implementation employs a modular design for achieving the data control module, the data FIFO module, and the algorithm computing module. Each module is independent and has clear functions and is responsible for specific tasks, respectively, thereby improving maintainability, scalability, and flexibility of performance optimization of the algorithm.

According to the embodiments of the present disclosure, an architecture employs a pipeline architecture design, and pipelined processing of data can be precisely controlled through the data control module. Furthermore, data backpressure is supported, and pre-storage or post-computation storage is not required, enabling online real-time computation.

According to the embodiments of the present disclosure, the architecture optimizes a traditional FIFO buffer, and data can be read multiple times under the control of the counter. Furthermore, the module also supports simultaneous operation of data buffering and computation, thereby improving computational efficiency.

According to the embodiments of the present disclosure, the architecture design supports flexible parameter configuration, and can adapt to federated learning tasks of different scales and different counts of participants, thereby improving applicability and scalability in practical applications.

According to the embodiments of the present disclosure, the system for hardware acceleration and optimization of the Krum algorithm in federated learning is implemented on an FPGA using Verilog HDL language. By introducing an efficient distance calculation module and parallel design, the execution performance of the algorithm is significantly optimized. In addition, by employing the pipeline architecture design and introducing the data control module, data backpressure is supported, and pre-storage or post-computation storage is not required, enabling online real-time computation. Finally, the hardware design also supports flexible parameter configuration, and can adapt to federated learning tasks of different scales and different counts of participants, thereby improving applicability and scalability in practical applications. The embodiments of the present disclosure will effectively compensate for CPU performance bottlenecks and provide important technical support for performance improvement of federated learning.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering indicates the same structure, wherein:

FIG. 1 is a schematic diagram illustrating an architecture of a system for hardware acceleration and optimization of a Krum algorithm in federated learning according to some embodiments of the present disclosure;

FIG. 2 is a schematic diagram illustrating an FSM of a data control module according to some embodiments of the present disclosure;

FIG. 3 is a schematic diagram illustrating an architecture of a federated learning model according to some embodiments of the present disclosure; and

FIG. 4 is a schematic diagram illustrating a comparison of performance of a Krum algorithm according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person of ordinary skill in the art to apply the present disclosure to other similar scenarios in accordance with these drawings without creative labor. Unless obviously obtained from the context or the context illustrates otherwise, the same numeral in the drawings refers to the same structure or operation.

It should be understood that the terms “system,” “device,” “unit” and/or “module” used herein are a way to distinguish between different components, elements, parts, sections, or assemblies at different levels. However, the terms may be replaced by other expressions if other words accomplish the same purpose.

As shown in the present disclosure and in the claims, unless the context clearly suggests an exception, the words “one,” “a,” “an,” “one kind,” and/or “the” do not refer specifically to the singular, but may also include the plural. Generally, the terms “including” and “comprising” suggest only the inclusion of clearly identified steps and elements, however, the steps and elements do not constitute an exclusive list, and the method or apparatus may also include other steps or elements.

Flowcharts are used in the present disclosure to illustrate the operations performed by a system according to the embodiments of the present disclosure, and the related descriptions are provided to aid in a better understanding of the method and/or system. It should be appreciated that the preceding or following operations are not necessarily performed in an exact sequence. Instead, steps can be processed in reverse order or simultaneously. Also, it is possible to add other operations to these processes or to remove a step or steps from these processes.

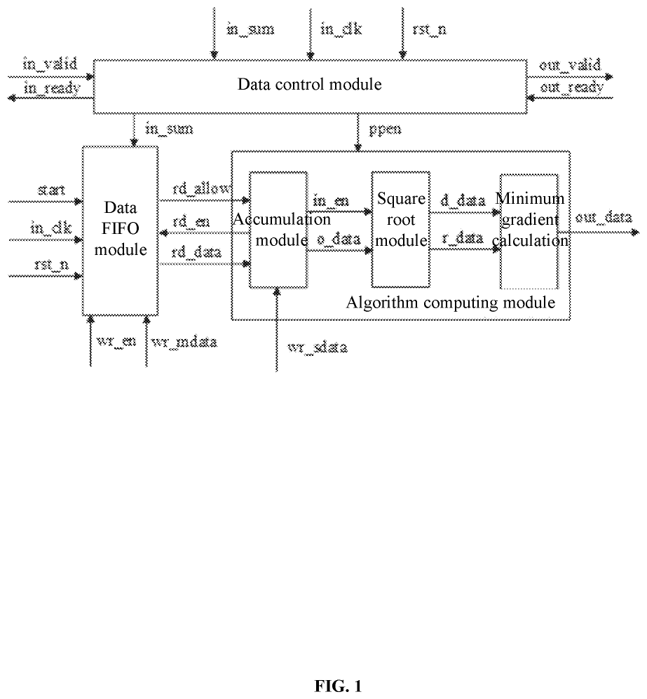

FIG. 1 is a schematic diagram illustrating an architecture of a system for hardware acceleration and optimization of a Krum algorithm in federated learning according to some embodiments of the present disclosure.

In some embodiments, the system for hardware acceleration and optimization of the Krum algorithm in federated learning may include a data control module, a data FIFO module, and an algorithm computing module. The data control module, the data FIFO module, and the algorithm computing module may be sequentially connected. The data control module may be connected to the algorithm computing module.

The data control module refers to a control unit configured to coordinate and manage internal data flow, processing timing, and inter-module interaction of the system. In some embodiments, the data control module is configured to perform pipeline control of the Krum algorithm. For example, the data control module may be implemented by a finite state machine (FSM). By receiving a start signal and monitoring a data processing state, the data control module generates a corresponding enable signal or control instruction to drive data buffering, transmission, and computation between the data FIFO module and the algorithm computing module. The data control module also supports a backpressure mechanism to prevent data loss.

The data FIFO module refers to a buffer unit configured to temporarily store data and perform data reading and writing following a First In First Out (FIFO) principle. In some embodiments, the data FIFO module is configured to cache a model gradient parameter of a client and perform cyclic reading. The data FIFO module may repeatedly provide the model gradient parameter of the client to the algorithm computing module through a cyclic reading manner for calculation with gradient parameters of subsequent other clients one by one. For example, the data FIFO module includes an FIFO buffer.

The FIFO buffer is a type of memory that stores and retrieves data in an order the data enters, where first-in data is read out first. The FIFO buffer is configured to manage data flow through a write pointer and a read pointer to ensure data is processed in order. The FIFO buffer is widely used in the fields such as computer systems and hardware design, and is particularly suitable for pipeline processing, data flow management, and buffer storage. Advantages of the FIFO buffer include simple and efficient implementation, and the ability to maintain data order consistency.

The algorithm computing module refers to a hardware computing unit specifically configured to perform core mathematical operations and logical comparisons required for a specific algorithm. In some embodiments, the algorithm computing module is configured to compute the Krum algorithm, including Euclidean distance calculation and minimum gradient calculation. For example, the algorithm computing module may be configured to calculate a Euclidean distance between two model gradients. The algorithm computing module may be further configured to perform summation, sorting, and comparison on distances of each model gradient to finally find a model gradient with a minimum model score. The algorithm computing module may be implemented by a processor.

The Krum algorithm is a robust aggregation approach applied in federated learning, aiming to prevent negative impacts of malicious participants or data poisoning on a training process of a global model. The Krum algorithm calculates a similarity between a model parameter update of each client and model parameter updates of other clients. The Krum algorithm selects a model parameter update that is closest to model parameter updates of the majority of other clients, thereby ensuring the quality and stability of the global model. This approach can effectively identify and exclude abnormal or malicious model updates, thereby improving robustness and defense capability of the system. Merely by way of example, operations of the Krum algorithm are shown in Table 1 below.

TABLE 1
Krum algorithm
Krum algorithm

Initialization: negotiate a model and various necessary parameters;
1. Distribute global model parameters W to all clients;
2. For each client cᵢ, execute concurrently: calculate a local model gradient gᵢ based on
local data, and send the local model gradient gᵢ to other clients;
3. After receiving the local model gradient gᵢ, each client calculates a pairwise distance
d_{i,j} = ||gᵢ - gⱼ||² between every two model gradients;
4. For each model gradient gᵢ, select n − f − 1 distances close to the model gradient gᵢ, i.e.,
the smallest n − f − 1 distances among {d_{i,1}, d_{i,2}, ... , d_{i,i-1}, d_{i,i+1}, ... , d_{i,n}}, sets the smallest
n − f − 1 distances as {d_{i,1}, d_{i,2}, ... , d_{i,n-f-1}}, and adds the smallest n − f − 1 distances up
$as a model score Kr ( i ) = {\sum }_{j = 1}^{n - f - 1} {d}_{i , j} of the model gradient {g}_{i} ;$
5. After calculating all model scores, obtains a model gradient g_{i*} with a smallest model
score;
6. Update a model parameter W = W − lr · g_{i*};
7. Repeat operations 1-6 until the model converges.

The model gradient refers to a partial derivative of a loss function with respect to a model parameter during model training, indicating a direction and a magnitude of parameter update. The model score refers to a quantitative metric for evaluating model parameters of an individual client in federated learning. lr represents a learning rate for controlling a step size when updating a model parameter. lr may be manually set or dynamically adjusted based on a data scale and a model complexity.

In some embodiments, the algorithm computing module may perform a plurality of sets of Euclidean distance calculations. The Euclidean distance is a metric for measuring a true distance between two points in a multidimensional space and used in the Krum algorithm to calculate a degree of difference between the model gradient parameters of different clients. Each set of Euclidean distance calculation includes receiving a model gradient from the data FIFO module and another model gradient of another client from an external input, and performing a distance calculation to obtain a Euclidean distance between the two model gradients. In some embodiments, after completing the distance calculation, the algorithm computing module may perform the minimum gradient calculation. For example, for each model gradient, the algorithm computing module sorts the Euclidean distances calculated between the model gradient and all other model gradients, and accumulates the smallest n−f−1 distances to obtain a model score of the model gradient.

In some embodiments, a pipeline architecture design is adopted, the data control module is responsible for orderly pipeline control of data, and the data control module supports backpressure calculation. For example, the data control module may control whether data enters the algorithm computing module or control whether the algorithm computing module performs a computation. Therefore, the embodiments of the present disclosure do not require pre-storage or post-computation storage, and can perform online real-time computation and pause computation at any time without data loss.

The backpressure calculation refers to a control mechanism for regulating a data flow rate. When a processing capability of a downstream processing unit (e.g., the algorithm computing module) does not match a data supply speed of an upstream unit (e.g., the data control module), the backpressure calculation may feed back a state to the upstream unit to pause or slow down the data supply, thereby preventing data overflow or loss.

More descriptions regarding the data control module performing the orderly pipeline control of data may be found in related descriptions later.

In some embodiments, the FSM is adopted to implement orderly pipeline control of data. The FSM is widely used in hardware control circuit design for decomposing a complex control logic into a finite number of stable states. Each state corresponds to a specific configuration of a system, and a transition between states is determined by preset rules. For example, the FSM mainly includes four basic elements: a state, an input, a state transition, and an output. Since the FSM has a finite number of states, the FSM may be implemented in practical engineering. However, this does not mean that the FSM only performs a finite number of processing operations. On the contrary, the FSM is a closed-loop system, finite yet infinite, and can use finite states to handle infinite matters.

The state transition condition refers to a logical judgment basis or a trigger rule used in the FSM for determining whether to migrate from a current state to a next state. In some embodiments, the state transition condition is dynamically adjusted according to an input data volume (in_sum) and a count of arithmetic logic units (ALU_MEM).

The input data volume (in_sum) refers to a total quantity or a total scale of data to be processed. For example, the input data volume (in_sum) may be a total count of clients participating in a current federated learning computation.

The count of arithmetic logic units (ALU_MEM) refers to a quantity of hardware units available for performing data processing or computing tasks. For example, the count of arithmetic logic units (ALU_MEM) may be a total count of hardware modules required for executing the Krum algorithm, such as a total count of an accumulation module, a square root module, and a minimum gradient calculation module.

In some embodiments, the state transition condition may be a magnitude relationship between the input data volume (in_sum) and the count of arithmetic logic units (ALU_MEM) to determine whether to transition from a processing state to another state. More descriptions regarding the states of the FSM, the buffering state, and the processing state may be found in related descriptions later.

In some embodiments, each state includes a ppen signal trigger condition for controlling data flow and backpressure. For example, when controlling data flow in stages through the FSM by controlling a ppen signal, the FSM may include a plurality of states. After the state transition condition is satisfied, the FSM sets the ppen signal to a low level or a high level to perform state transition.

In some embodiments, after receiving the start signal (start) (e.g., a rising edge signal), the data control module drives a transition of a processing stage of data through the FSM, and precisely tracks progress of the data in a plurality of processing stages through a counter. According to a current processing stage, the data control module generates a ppen signal and transmits the ppen signal to the algorithm computing module to control orderly flow of the data among buffering, processing, clearing, and other stages, thereby achieving efficient data transmission.

The start signal (start) refers to a signal used to trigger an FSM to start a preset function or an operation flow. For example, The start signal is a pulse signal.

The processing stage refers to a specific operation phase that data experiences in the system. For example, the processing stage may include a data buffering stage, a data processing stage, and a data clearing stage. These stages together constitute a complete lifecycle of data from input to output.

In some embodiments of the present disclosure, by performing key computations of the Krum algorithm based on hardware implementation and adopting a pipeline architecture of data control, FIFO buffering, and algorithm computing, the computation speed is significantly improved. Based on the data control module using the FSM, through the ppen signal and the backpressure mechanism, orderly flow and real-time processing of data are achieved. The problem of data loss caused by a mismatch in the computation speed is avoided, and system stability is ensured. The state transition condition is dynamically adjusted according to the input data volume and the count of arithmetic logic units, enabling the system to flexibly adapt to tasks of different scales, achieving online real-time computation, and reducing dependency on large-scale caching and system delay.

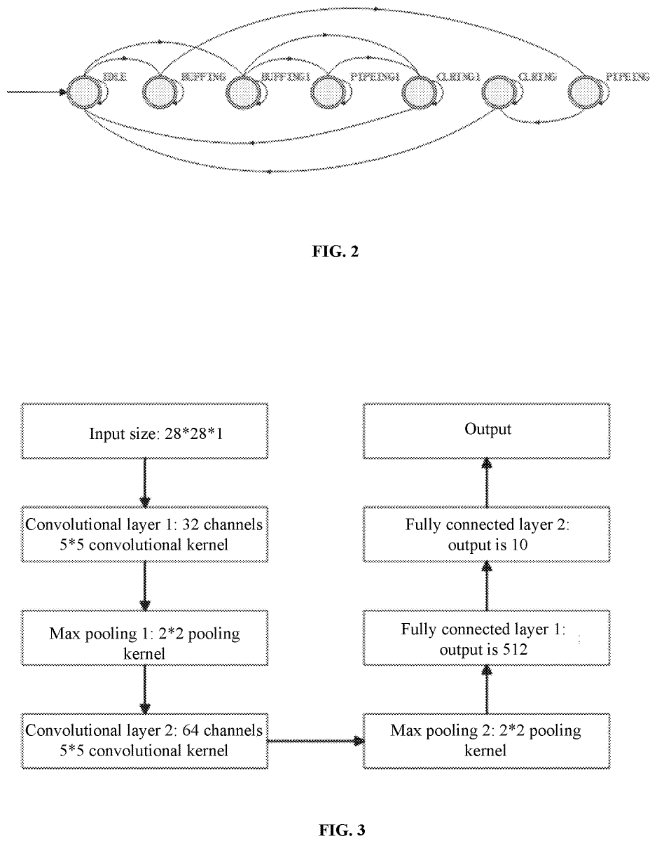

FIG. 2 is a schematic diagram illustrating an FSM of a data control module according to some embodiments of the present disclosure. In some embodiments, as shown in FIG. 2, the data control module implements the pipeline control of data through the FSM.

In some embodiments, the FSM may include seven states: an idle state (IDLE), a first buffering state (BUFFING) and a second buffering state (BUFFING1), a first pipeline processing state (PIPEING) and a second pipeline processing state (PIPEING1), a first clearing state (CLRING) and a second clearing state (CLRING1).

The idle state (IDLE) refers to an initial or standby state of the FSM. In the idle state (IDLE), the FSM waits for a trigger of a start signal (start) to transition to another state.

The buffering state includes the first buffering state (BUFFING) and the second buffering state (BUFFING1). In the buffering state, the data FIFO module receives and temporarily stores gradient data from an external source. Two different buffering states are set to handle data inputs of different scales, respectively.

The processing state includes the first pipeline processing state (PIPEING) and the second pipeline processing state (PIPEING1). In the processing state, the algorithm computing module is activated to perform a core Krum algorithm computation.

The clearing state includes the first clearing state (CLRING) and the second clearing state (CLRING1). The clearing state is used to reset the counter inside the system and clear a cache area after computation is completed, preparing for a next computation task. The counter is a timing logic component that drives operation of the FSM, and a value stored inside the counter determines a state of the FSM.

In some embodiments, states of the FSM may be increased, decreased, or merged according to specific design requirements. For example, a function of the clearing state may be merged into an initialization logic of the idle state, thereby simplifying the design of the FSM.

In some embodiments, the FSM may be divided into two processing paths, which are a first processing path (IDLE-BUFFING-PIPEING-CLRING) and a second processing path (IDLE-BUFFING1-PIPEING1-CLRING1). The first processing path includes processing from the idle state (IDLE), and sequentially entering the first buffering state (BUFFING), the first pipeline processing state (PIPEING), and the first clearing state (CLRING). The second processing path includes processing from the idle state (IDLE), and sequentially entering the second buffering state (BUFFING1), the second pipeline processing state (PIPEING1), and the second clearing state (CLRING1). Whether data enters the first processing path or the second processing path is determined by the input data volume (in_sum) and the count of arithmetic logic units (ALU_MEM). As shown in FIG. 1, a required count of units for executing the Krum algorithm is 3 (including the accumulation module, the square root module, and the minimum gradient calculation module, more descriptions may be found in the related descriptions later), then ALU_MEM=3.

In some embodiments, when the input data volume (in_sum) is not greater than the count of arithmetic logic units (ALU_MEM) (e.g., in_sum<=3), indicating that all input data may be processed in parallel by hardware at one time, the FSM enters the second processing path, i.e., the FSM enters the second buffering state (BUFFING1), the second pipeline processing state (PIPEING1), and the second clearing state (CLRING1), to ensure fast processing and resource optimization for small data volumes.

In some embodiments, when the input data volume (in_sum) is greater than the count of arithmetic logic units (ALU_MEM), indicating that data needs to be processed in batches through a pipeline process, the FSM enters the first processing path, i.e., the FSM enters the first buffering state (BUFFING), the first pipeline processing state (PIPEING), and the first clearing state (CLRING), for processing in a conventional pipeline mode.

For example, the data control module may internally include a digital comparator. After receiving the start signal, the digital comparator compares a value of the input data volume (in_sum) with a value of system-configured ALU_MEM. A comparison result (e.g., a logic high or low level) directly serves as a decision basis for the FSM to transition from the idle state, guiding the FSM to enter one of the two different processing paths.

In some embodiments, each state of the FSM may determine three output signals, including the ppen signal, an in_ready signal, and an out_valid signal. The ppen signal indicates whether to compute current data, i.e., whether to enter the algorithm computing module. The in_ready signal indicates whether data still exists in the algorithm computing module, i.e., whether data in the algorithm computing module is being computed or whether data has been computed but has not been transmitted to a next module for continued computation. The out_valid signal indicates whether there is data output. The three signals cooperate with each other to determine an order in which data flows into the algorithm computing module.

For example, an output logic of the FSM may be a combinational logic circuit (e.g., a decoder). The combinational logic circuit takes a current state code of the FSM as an input and, according to a preset logic truth table, outputs levels of the ppen signal, the in_ready signal, and the out_valid signal in real time. The preset logic truth table may include a correspondence between states of the FSM, the ppen signal, the in_ready signal, and the out_valid signal. Merely by way of example, in the idle state (IDLE) or the first buffering state (IBUFFING), the combinational logic circuit may output ppen=0 (no computation), in_ready=1 (indicating that the system is ready to receive input), and out_valid=0 (no valid data output).

In some embodiments of the present disclosure, by using the FSM with dual processing paths and seven states, an optimal computation flow can be dynamically selected according to a relationship between the input data volume and a hardware resource amount. The adaptive mechanism adopts an efficient parallel mode for small-batch data and adopts a high-throughput pipeline mode for large-batch data, maximizing the processing efficiency. Meanwhile, the ppen signal, the in_ready signal, and the out_valid signal precisely generated in each state construct a clear and reliable control interface, ensuring orderly data flow and stable integration of modules, thereby enhancing overall performance and robustness of a hardware accelerator.

In some embodiments, the data control module may generate a gate switching signal according to the input data volume (in_sum) and the count of arithmetic logic units (ALU_MEM), and send the gate switching signal to a first multiplexer. The gate switching signal controls the first multiplexer to connect a gate terminal to a direct input, or to switch the gate terminal to an FIFO output port.

The gate switching signal refers to a control signal used to control a multiplexer to select an input channel as an output. For example, the gate switching signal may be a binary level, where a high level selects one path and a low level selects another path (e.g., the first processing path or the second processing path). For example, a digital comparator is set inside the data control module. The digital comparator receives the in_sum and the ALU_MEM as inputs and performs a “less than or equal to” comparison operation. When the in_sum is less than or equal to the ALU_MEM, the comparator outputs a low level as the gate switching signal; otherwise, the comparator outputs a high level.

The first multiplexer is a digital logic circuit that selects one of a plurality of input signals as an output according to one or more selection signals. For example, a two-to-one multiplexer selects one of two input ports as an output according to the gate switching signal. One input terminal of the first multiplexer is connected to an original data input bus (i.e., the direct input, corresponding to the second processing path) of the system, and another input terminal of the first multiplexer is connected to a read data port (i.e., the FIFO output port, corresponding to the first processing path) of the data FIFO module. The gate switching signal is connected to a selection control terminal of the multiplexer.

In some embodiments of the present disclosure, by generating the gate switching signal to control the multiplexer, dynamic selection of a data processing path is achieved. This mechanism allows small-batch data to bypass the FIFO buffer for direct computation, avoiding unnecessary memory read/write delays and power consumption. This hardware-based physical path switching significantly enhances flexibility and efficiency of the system in case of processing data of different scales, especially when processing fragmented tasks, and can substantially shorten processing time.

In some embodiments, the data control module is configured to: in response to the FSM entering the first buffering state (BUFFING), the first pipeline processing state (PIPEING), and the first clearing state (CLRING), determine, at intervals of a first cycle, whether to perform path switching according to a remaining data volume and the count of arithmetic logic units (ALU_MEM); and in response to a determination result being to perform path switching, switch the FSM to the second processing path, i.e., switch to the second buffering state (BUFFING1), the second pipeline processing state (PIPEING1), and the second clearing state (CLRING1).

The first cycle refers to a preset time interval for performing state monitoring and logic determination when the FSM operates in a conventional pipeline path (i.e., the first processing path). For example, a duration of the first cycle may be one system clock cycle.

The remaining data volume refers to a count of data blocks that have been received but not yet processed in a current processing flow. The remaining data volume may be obtained from a remaining data counter integrated in the system.

In some embodiments, if the remaining data volume is less than or equal to the ALU_MEM, the processing path of the FSM is switched from a conventional path to a fast path, i.e., the FSM is switched from the first processing path to the second processing path. For example, the processing path of the FSM is switched from the first pipeline processing state (PIPEING) to the second buffering state (BUFFING1), the second pipeline processing state (PIPEING1), and the second clearing state (CLRING1).

In some embodiments of the present disclosure, by dynamically monitoring the remaining data volume during processing of a large batch of data, and automatically switching from a high-throughput conventional pipeline path to a low-latency fast processing path when the data volume decreases to a certain threshold, the problem of low efficiency of a conventional deep pipeline when processing sparse tail data is solved, waste of clock cycles and power consumption caused by an inability to fill the pipeline is avoided, and the overall efficiency of the system in processing tasks is significantly improved.

In some embodiments, the data control module is further configured to: after switching the FSM to the second processing path, i.e., after switching to the second buffering state (BUFFING1), the second pipeline processing state (PIPEING1), and the second clearing state (CLRING1), in response to a backpressure frequency being less than a first backpressure threshold, inject a reset signal into the counter through a second multiplexer at a terminal clock edge of the second pipeline processing state (PIPEING1).

The backpressure frequency refers to a proportion of clock cycles in which a backend receiving capability signal is at a low level within an observation period to a total observation period, and is used to measure a congestion level of the backend. A duration of the observation period may be set based on experience, such as 20 system clock cycles, 30 system clock cycles, or the like.

The first backpressure threshold refers to a preset proportional value used to determine whether backend data reception is smooth. For example, the first backpressure threshold is 10% or 0.1.

The second multiplexer refers to a hardware selection unit for controlling an input signal source of the counter, and is used to switch between a normal count signal and a forced reset signal. Two input terminals of the second multiplexer are respectively connected to a normal count logic (e.g., a current count value plus one) and the reset signal (e.g., a constant 0 or an initial value). The second multiplexer is configured to perform physical switching between a conventional count path and a forced reset path. During normal operation, the counter is allowed to increment sequentially to maintain pipeline timing. In response to detecting high backpressure and a need for fast completion, the second multiplexer responds to the gate switching signal, directly truncates conventional increment logic, and bypasses the reset signal to the counter, thereby providing a physical channel for state transition.

The terminal clock edge refers to a system clock rising edge corresponding to processing a last data block in a current gradient vector.

The reset signal refers to a specific numerical signal generated by optimization logic, and is corresponding to an initial value 0 of the counter.

In some embodiments, a selection terminal of the second multiplexer is driven by a control logic, and an output of the control logic is a comparison result of the backpressure frequency and the first backpressure threshold. When the condition is satisfied, the multiplexer selects the reset signal as an output, and feeds the reset signal to a data input terminal of the counter, thereby resetting the counter at a next clock rising edge. Merely by way of example, if the backend (e.g., the algorithm computing module) receives data extremely fast (i.e., the backpressure frequency is very low), at a moment when processing of current gradient data is about to end, the second multiplexer is controlled to select the reset signal and inject the reset signal into the counter, thereby merging operations of the first clearing state (CLRING) and a next first buffering state (BUFFING) into the same clock cycle.

In some embodiments of the present disclosure, a backend processing capability is evaluated by dynamically monitoring the backpressure frequency. When backend reception is smooth, the system injects the reset signal to reset a state machine driving the counter in advance at an end of current task processing. The mechanism effectively compresses state transition operations, such as clearing and next buffering, into one clock cycle, to achieve seamless connection between different data processing tasks, thereby significantly reducing state transition overhead, and maximizing data throughput in high-bandwidth scenarios.

In some embodiments, the data control module further includes two important input signals: an in_valid signal and an out_ready signal. The in_valid signal indicates whether there is data waiting for computation, and is a data input flag. The out_ready signal indicates whether the backend is capable of receiving data, and is a backpressure signal flag.

The in_valid signal refers to a signal used to indicate whether valid data is available for the data FIFO module to send. For example, when the data FIFO module prepares a data unit, the data FIFO module simultaneously sets the in_valid signal to a high level as a flag for valid data.

The out_ready signal refers to a signal that indicates whether the algorithm computing module is ready to receive data. For example, when an internal buffer of the algorithm computing module is full or the algorithm computing module is processing data, the algorithm computing module sets the out_ready signal to a low level, indicating that new data cannot be received temporarily. This is a key flag for implementing a backpressure mechanism.

The data control module generates the ppen signal through different states of the FSM, and transmits the ppen signal to the algorithm computing module, dynamically scheduling computing resources, thereby precisely controlling a pipelined operation process of data. Through the mechanism, the module can efficiently coordinate data input, processing, and output in different states, thereby ensuring orderly execution of computing tasks and optimal utilization of resources, and significantly improving overall computing performance and system throughput.

In some embodiments, after receiving the start signal (start), the data control module selects to first enter the buffering state (e.g., the first buffering state (BUFFING) or the second buffering state (BUFFING1)) according to a magnitude relationship between the input data volume (in_sum) and the count of arithmetic logic units (ALU_MEM), including: if the in_sum is less than or equal to the ALU_MEM, entering the second buffering state (BUFFING1); otherwise, entering the first buffering state (BUFFING).

In some embodiments, if it is detected that there is data input waiting for computation, i.e., the in_valid signal is at a high level, the data control module adjusts output signals, including the ppen signal, the in_ready signal, and the out_valid signal, according to the current buffering state (e.g., the first buffering state (BUFFING) or the second buffering state (BUFFING1)).

In the buffering state, whether the first buffering state (BUFFING) or the second buffering state (BUFFING1), the ppen signal equals the in_valid signal. At this time, the in_valid signal is at a high level (e.g., logic 1), indicating that the buffering state is always ready to receive data, and the ppen signal is also at the high level. Meanwhile, since the in_ready is at the high level 1, data buffering is not completed, and the out_valid signal is at a low level (e.g., logic 0), indicating that no data is output. When in_ready=1, the backend (e.g., the algorithm computing module) needs data to proceed with computation. This logic ensures that the algorithm computing module can be pre-activated in the buffering state, while clearly indicating that the system is in a receiving state.

In some embodiments, when data stored in the buffering state equals the count of arithmetic logic units (ALU_MEM), and there is still data input waiting for computation, i.e., the in_valid signal remains at the high level, the data control module switches to the processing state (e.g, the first pipeline processing state (PIPEING) or the second pipeline processing state (PIPEING1). At this time, the output signals change again with the state. When there is no new data input waiting for computation, i.e., the in_valid signal is at the low level, and only cached data remains, the data control module enters the clearing state (e.g., the first clearing state (CLRING) or the second clearing state (CLRING1)). The output signals, including the ppen signal, the in_ready signal, and the out_valid signal, are adjusted according to the clearing state. For example, the output signals are adjusted according to the processing state or the clearing state based on a preset logic truth table.

In some embodiments of the present disclosure, by introducing the in_valid signal and the out_ready signal, a standard handshake protocol is implemented, ensuring reliability of data transmission. The system can dynamically select an optimal processing path according to data volume and hardware resources, and precisely control output signals at each stage through the state machine. The mechanism ensures efficient and orderly operation of the data pipeline while achieving flexible backpressure control, significantly improving processing performance, stability, and resource utilization of the hardware accelerator under different loads.

In some embodiments, to optimize algorithm execution performance and improve the overall operation speed of the algorithm, the embodiments of the present disclosure improve a conventional FIFO buffer and design a flexible FIFO buffer supporting multiple reads.

For example, to support multiple reads, a read pointer control logic of the FIFO buffer may be improved. When repeated reading of cached data is required, an external control signal prevents the read pointer from resetting or stopping after completing a full read. Instead, the external control signal forces the read pointer to return to a starting address of a storage area, thereby achieving cyclic reading of the same data. As another example, multiple reads may be implemented by adding a feedback path and a data selector between an output terminal and an input terminal of the FIFO buffer. When repeated reading is required, the data selector redirects output data of the FIFO buffer back to the input terminal of the FIFO buffer, forming a closed loop, such that the data can be continuously read out without external memory intervention.

More descriptions regarding the FIFO buffer may be found in the related descriptions above.

As shown in the formula d_{i.j}=∥gᵢ−gⱼ∥² in Table 1 for the Krum algorithm, each client needs to determine a Euclidean distance between a local model gradient of the client and a local model gradient of another client. If each calculation repeatedly requests the model gradient of the client, the calculation efficiency is greatly reduced. Therefore, to improve calculation performance, the embodiments of the present disclosure fix a model gradient of a client and determine a Euclidean distance between the model gradient of the client and a model gradient of another participant (i.e., another client). For this purpose, an improved FIFO buffer adds a counter for controlling a count of readouts, and a maximum value of the count of readouts is determined by a count n of participants in federated learning. In addition, the FIFO buffer also supports configuration of a data width and a data depth to meet requirements of different clients and model gradients.

In some embodiments, the data FIFO module is an FIFO buffer supporting multiple readouts. To reduce performance loss caused by repeatedly reading memory data, a traditional FIFO buffer is optimized, and the data FIFO module is designed. The FIFO buffer is configured to cache a model gradient of a client and complete calculation of a model score of the client through repeated reading.

In some embodiments, the FIFO buffer is configured to cache a model gradient parameter of a client and complete calculation of a model score of the client through repeated reading, including: as shown in the Krum algorithm, assuming that a count of clients is cₙ, if a model score of a model gradient of a client cᵢ is to be calculated, caching a model gradient gᵢ of the client cᵢ in the FIFO buffer, and repeatedly reading the model gradient gᵢ to calculate a Euclidean distance between the model gradient gᵢ and model gradients corresponding to other clients c₁, c₂, . . . cᵢ₋₁, cᵢ₊₁, . . . cₙ.

For this purpose, the improved FIFO buffer adds a counter, and a count of readouts is controlled through the counter, and a maximum value of the count of readouts is determined by a count n of participants in federated learning. Since the count (i.e., a count of all clients participating in the calculation) of participants in the federated learning is determined before the algorithm is executed, assuming that the count of participants is n, the count of readouts is n−1. After the model gradient gᵢ is read n−1 times, a model gradient gᵢ₊₁ of a next client is then cached until an algorithm operation ends.

Merely by way of example, the FSM of the data control module is responsible for controlling an entire process. When a score of the client cᵢ needs to be determined, the FSM enters the buffering state, and the model gradient gᵢ is written into the FIFO buffer. After the writing is completed, the FSM enters the processing state and enables the counter, and an upper limit value of the counter is set to n−1 (n is a total count of clients). Each time the algorithm computing module completes one Euclidean distance calculation, a reading operation of the FIFO buffer is triggered once. After data in the FIFO buffer is completely read once, the read pointer is reset. When a value of the counter reaches n−1, the model gradient has been compared with all other clients, and at this time, the FSM transitions back to the buffering state to start processing a model gradient gᵢ₊₁ of a next client cᵢ₊₁.

In some embodiments, in the data FIFO module, data caching and computation are performed simultaneously to improve calculation efficiency. Following the above example, to save time, the data FIFO module does not need to wait for the model gradient gᵢ of the client cᵢ to be completely cached, and allows the Euclidean distance calculation with model gradients of other clients to start after caching a first gradient parameter. In addition to an empty signal (empty) and a full signal (full) that a traditional FIFO buffer has, the data FIFO module further includes a read enable signal (rd_allow) and a write enable signal (wr_allow). When a write enable is high (the write enable is controlled by a host computer), a write operation may be performed, and the FIFO buffer is not full of data, i.e., not full (!full), the write enable signal wr_allow is at a high level, and data is written into the data FIFO module. When a read enable is high (the read enable is controlled by the algorithm computing module, and the read enable being high indicates that data is to be read and data computation is to start) and the FIFO is not an empty signal (!empty), the data is read out. Through this design, the algorithm computing module can start a computation process in advance before a gradient is completely cached, greatly shortening an intermediate calculation waiting time, thereby further improving overall calculation performance and efficiency.

In some embodiments of the present disclosure, by designing the FIFO buffer supporting multiple reads and a dedicated counter control logic, repeated memory access to gradient data of the same client is avoided, and data rereading overhead is significantly reduced. By implementing simultaneous caching and computation and adopting independent read and write enable signals, the system can process data in a pipelined manner, greatly shortening the computation waiting time. The design effectively improves the overall operation speed and the data throughput rate of the Krum algorithm and optimizes the utilization efficiency of hardware resources.

In some embodiments, by controlling the count of readouts through the counter, after the model gradient gᵢ is read n−1 times, the model gradient gᵢ₊₁ is cached until the algorithm operation ends, including: in response to the count of readouts being less than n−1, generating a pointer reset signal, and the pointer reset signal controlling the data FIFO module to reset a read pointer of a memory array to a starting address of the model gradient gᵢ.

The pointer reset signal refers to a pulse signal generated by a control logic for directly operating an address controller of a memory to restore a value of the address controller to a specific initial value.

The memory array refers to a hardware unit that actually stores data inside the data FIFO module, such as a block RAM (BRAM) or a distributed RAM in FPGA.

In some embodiments, the pointer reset signal is generated through a counter and a comparator. The counter is capable of tracking a count of times a complete model gradient is read out. When one complete gradient reading ends and a comparator determines that a current count value is less than n−1, the control logic generates the pointer reset signal. In some embodiments, the pointer reset signal is generated through the FSM of the data control module. A state transition logic of the FSM is responsible for monitoring a gradient reading process and a total count of readouts. When the FSM determines that one complete reading is completed and the total count of readouts is less than n−1, an output logic of the FSM directly generates the pointer reset signal.

In some embodiments, the pointer reset signal not only controls the read pointer but also synchronously triggers a write enable masking logic. When the pointer reset signal is valid, the write enable masking logic temporarily prohibits a write operation to the data FIFO module to prevent gradient data being repeatedly read from being overwritten by newly input data, thereby ensuring integrity of the data during repeated reading.

In some embodiments of the present disclosure, by generating the pointer reset signal to directly control resetting of an internal read pointer of the FIFO, zero-copy repeated reading of locally cached data is implemented. The mechanism uses a hardware logic to avoid frequent access to an external memory, thereby greatly reducing bus bandwidth occupation and power consumption, and significantly improving an energy efficiency ratio of algorithm execution and overall calculation performance.

In some embodiments, the data FIFO module is further configured to: when repeatedly reading the model gradient gᵢ, in response to the count of readouts being greater than a preset readout threshold, cache header data of the model gradient gᵢ₊₁.

The preset readout threshold refers to a countdown value used to trigger a prefetch operation, indicating that when a current count of readouts of the model gradient exceeds the value, a next model gradient is loaded.

The header data refers to a plurality of data blocks at the beginning of a data vector, such as initial data in the model gradient gᵢ₊₁.

In some embodiments, the data FIFO module may start reading and caching a next model gradient gᵢ₊₁ in advance when the count of readouts is greater than the preset readout threshold, and send the header data of the model gradient gᵢ₊₁ into a computation pipeline to fill a timing gap of a calculation unit between an end of the model gradient gᵢ and a start of the model gradient gᵢ₊₁.

In some embodiments of the present disclosure, by prefetching the header data of a next gradient before a current gradient processing ends, a timing gap that may occur in the computation pipeline during gradient switching is effectively filled. The mechanism eliminates idle time of the calculation unit, and ensures high saturation of the pipeline, thereby maximizing utilization of hardware resources, and significantly improving the overall calculation performance and the data throughput of the algorithm.

In some embodiments, the data FIFO module is further configured to: at intervals of a second cycle, adjust the preset readout threshold according to a current data dimensional feature and the backpressure frequency.

The second cycle refers to a preset time interval for periodically performing an adjustment operation of the preset readout threshold. The second cycle may be set based on experience. For example, a duration of the second cycle may be set to 10000 system clock cycles.

The current data dimensional feature refers to a data length and complexity of a gradient vector. For example, the current data dimensional feature may be a numerical value representing a count of data elements included in the gradient vector. The higher the numerical value of the current data dimensional feature, the longer the single computation time, and the greater the occupancy pressure on the count of arithmetic logic units.

In some embodiments, the data FIFO module may adjust the preset readout threshold according to a preset table. The preset table may include a correspondence relationship among the current data dimensional feature, the backpressure frequency, and the preset readout threshold. The preset table may be set based on experience. When a value of the current data dimensional feature is moderate (e.g., the value is within a preset increase range) and backpressure from the backend is completely absent, a constant K value for adjusting the preset readout threshold increases. In this case, the header data of the gᵢ₊₁ may be input into idle slots of a pipeline in advance before gᵢ is completed. When the value of the current data dimensional feature is high or the backpressure frequency is high (e.g., greater than a preset reduction threshold), the K value may be decreased to avoid data congestion.

In some embodiments of the present disclosure, adaptive regulation of pipeline control is achieved by periodically and dynamically adjusting a trigger threshold for a prefetch operation based on the current data dimensional feature and the backpressure frequency from the backend. The mechanism can perform active prefetching to improve pipeline utilization when the processing capability of the backend is sufficient, and reduce prefetching to avoid data congestion when the backend is congested or data processing is complex, thereby maintaining high efficiency and high stability under different workloads, and enhancing the overall performance and robustness of the system.

In some embodiments, the data FIFO module is further configured to: in response to the backpressure frequency being greater than a second backpressure threshold, before caching the header data, control the memory array to stop caching during a preset protection period.

The second backpressure threshold refers to a preset proportional numerical value used to determine whether the system is in a severe congestion state. For example, the second backpressure threshold may be set to 90% or 0.9.

The preset protection period refers to a preset duration used to forcibly stop a data caching operation. For example, the preset protection period may be set to 50, 70, or 100 system clock cycles, etc.

In some embodiments, after gᵢ is read n−1 times, the data FIFO module may stop caching for the preset protection period and then cache gᵢ₊₁. For example, stopping caching includes: the FSM entering a temporary state (WAIT_SLOT), where the wr_allow signal is forced to 0 in the temporary state, and entry into the first buffering state (BUFFING) of next data is allowed only after a number of clock cycles corresponding to the preset protection period.

In some embodiments of the present disclosure, by actively pausing data caching upon detection of extreme congestion, a protective waiting period is introduced. The mechanism can provide buffering time for the backend processing unit without interrupting an overall task, thereby effectively preventing the risks of pipeline overflow or hardware overheating caused by excessive data prefetching, and significantly enhancing the robustness and stability of the system under high load.

In some embodiments, the algorithm computing module includes an accumulation module, a square root module, and a minimum gradient calculation module. The accumulation module may be configured to perform an addition operation and a multiplication operation for calculating a Euclidean distance between gradients (i.e., a Euclidean distance of model gradients) of two participants. The square root module may be configured to perform a square root operation on a sum of squares result output by the accumulation module to obtain a true Euclidean distance between participants. The minimum gradient calculation module may be configured to select smallest n−f−1 valid values from Euclidean distances calculated from a plurality of participants, to exclude influence of abnormal participants and ensure accuracy of model update. Subsequently, the selected smallest n−f−1 valid values are summed to calculate a valid distance sum, and the valid distance sum is used as a basis for model update, where n denotes a count of participants, and f denotes a preset count of tolerable abnormal or malicious participants. For example, in federated learning with n participants, if a preset maximum count of tolerable malicious participants is f, when a model score is calculated, the smallest n−f−1 distances need to be selected from n−1 distances for subsequent calculation.

The above three modules may be connected based on a pipeline architecture. That is, an output of the accumulation module may serve as an input of the square root module, and an output of the square root module may serve as an input of the minimum gradient calculation module, thereby achieving efficient and continuous data processing.

In some embodiments, the square root module may directly use a pre-designed and verified intellectual property (IP) core (e.g., a cordic IP core officially provided by Xilinx) to implement a square root operation for completing the square root operation on the sum of squares. The IP core is configured in a square root operation mode, receives the sum of squares output by the accumulation module as input, and after internal iterative calculation, outputs a signal representing a quotient (i.e., a square root result) and a signal representing a remainder, i.e., outputs of the square root module are d_data and r_data, representing the quotient and the remainder, respectively.

In some embodiments, the accumulation module may implement start control and data flow synchronization management of a computation process through the ppen signal generated by the data control module, including: when the ppen signal is valid, first generating an absolute difference of two pieces of input data (model gradients of two clients) through a difference calculation and absolute value extraction circuit, and further obtaining a square of the absolute difference through a square operation; performing point-by-point accumulation on the input data based on the cooperation of the counter and an accumulator until the counter reaches a set count of neurons (NEURON_NUM), and outputting an accumulation result (o_data), i.e., a sum of squares result.

In some embodiments of the present disclosure, by decomposing the algorithm computing module into the accumulation module, the square root module, and the minimum gradient calculation module, hardware pipeline processing of core computations of the Krum algorithm is achieved, significantly improving data throughput. Using dedicated hardware circuits such as IP cores and sorting networks, complex mathematical operations and screening logic are completed at high speed and low latency, and computation efficiency of the dedicated hardware circuits is far higher than that of general-purpose software implementations. The design achieves deep hardwareization of a robust screening mechanism of the Krum algorithm, ensuring fast and accurate calculation of a basis for model update, and providing strong guarantee for security and efficiency of the entire system.

In some embodiments, to achieve delayed synchronous processing of the ppen signal, a delayed clocking operation is performed via delay_ppen. For example, the delayed clocking operation is implemented through a D-type flip-flop or a shift register. To ensure correctness of the pipelined operation, by delaying the ppen signal by only one clock cycle, the computation efficiency can be significantly improved.

In some embodiments of the present disclosure, by delaying the ppen signal by only one clock cycle, precise synchronization of control signals with data flow in the pipeline is achieved. The mechanism effectively avoids data processing errors or pipeline conflicts that may be caused by timing mismatches, ensures correctness of data processing when the hardware accelerator operates at a high speed, and ensures efficient and stable operation of the pipeline without increasing design complexity, thereby guaranteeing performance and reliability of the overall system.

In some embodiments, in the minimum gradient calculation module, first, Euclidean distance data calculated by each participant is received and stored in a register; then, to achieve efficient data screening and comparison, a parallel comparison mechanism is adopted to quickly compare the received Euclidean distance data in a storage area, the smallest n−f−1 valid distances are selected from the received Euclidean distance data; finally, the selected smallest n−f−1 valid distances are summed to calculate a total valid distance, and the total valid distance is fed back to a front end. Through the parallel comparison mechanism, the algorithm computing module can exclude influence of abnormal values and abnormal participants during processing, ensuring reliability of calculation results.

The front end refers to a module or a system part that receives processing results of a specific module and uses the processing results for subsequent operations or control. For example, the front end may be a top-level module responsible for overall flow control of the Krum algorithm. In some embodiments, the front end collects total valid distances of all clients, selects minimum gradient data as current model parameters. If federated learning training is completed, the model parameters are final model parameters; if federated learning tasks need to continue, the model parameters need to be issued to conduct training for a new global model.

In some embodiments of the present disclosure, by adopting register array storage and the parallel comparison mechanism, high-speed screening of Euclidean distances is achieved, and efficiency of the high-speed screening is far higher than that of traditional software sorting algorithms. The solution can quickly and accurately eliminate abnormal values, select the n−f−1 valid distances, and combined with an efficient hardware accumulator, rapidly calculate the valid distance sum serving as the basis for model update, thereby significantly shortening execution time of the Krum algorithm, and improving the processing performance and robustness of the entire system.

To verify the acceleration effect of the embodiments of the present disclosure, the algorithm was implemented on a host CPU, a graphics processing unit (GPU), and an FPGA respectively, and comparative experiments were conducted. In the comparative experiments, the CPU was an Intel® Core™ i5-8300H @2.30 GHz, the GPU was an NVIDIA GeForce GTX 1060, and the FPGA was a Stratix V GX development board, with a peripheral component interconnect express (PCIe) using gen3×8 and operating at a frequency of 400 MHz. The experiment design aims to evaluate acceleration performance of hardware implementation of the Krum algorithm. The FPGA is a chip that can change an internal structure of the FPGA through programming. The FPGA has high flexibility and configurability. The FPGA can optimize and accelerate an algorithm at a hardware level. The FPGA includes a plurality of logic cells. Each of the plurality of logic cells includes components such as a lookup table (LUT) and a flip-flop. The FPGA can implement complex combinational and sequential logic. A user writes programs using a hardware description language (e.g., Verilog or VHDL) to define a function of a logic circuit. The FPGA configures hardware resources of the FPGA according to the programs, thereby implementing efficient parallel processing and customized computation. Due to flexibility and efficient parallel computing capability, the FPGA is widely applied in the fields such as data processing acceleration, communication, image processing, and artificial intelligence.

The federated learning algorithm is implemented on a host PC to generate a local model gradient parameter. The experiment uses a classic MNIST dataset. The MNIST dataset includes handwritten digit images, covering 10 categories. A dimension of each image is 28×28 pixels. FIG. 3 is a schematic diagram illustrating an architecture of a federated learning model according to some embodiments of the present disclosure. Regarding a model architecture, as shown in FIG. 3, a simple convolutional neural network (CNN) suitable for a federated learning framework is selected. The model includes a first convolutional layer (convolutional layer 1). A convolution kernel of the first convolutional layer is 5×5. A channel count of the first convolutional layer is 32. The first convolutional layer is followed by a first 2×2 max pooling layer (max pooling 1). A ReLU activation function is used. The first max pooling layer is followed by a second convolutional layer (convolutional layer 2). A convolution kernel of the second convolutional layer is 5×5. A channel count of the second convolutional layer is 64. The second convolutional layer is followed by a second 2×2 max pooling layer (max pooling 2). The second max pooling layer is finally connected by a first fully connected layer and a second fully connected layer (fully connected layer 1 and fully connected layer 2). In the experiment, model parameters are distributed among a plurality of clients. To evaluate performance, 10 clients are set for model training. Each of the plurality of clients accesses only local data. Each of the plurality of clients generates a local model gradient parameter of the client. During a training process, 10 rounds of local training are performed on each of the plurality of clients.

The Krum algorithm aims to calculate a Euclidean distance between local model gradient parameters of each pair of participants and calculate a score of the Euclidean distance. A local model gradient parameter is determined by a neural network model architecture, as shown in FIG. 3. After calculation, a gradient parameter count of the architecture is about 35 MB.

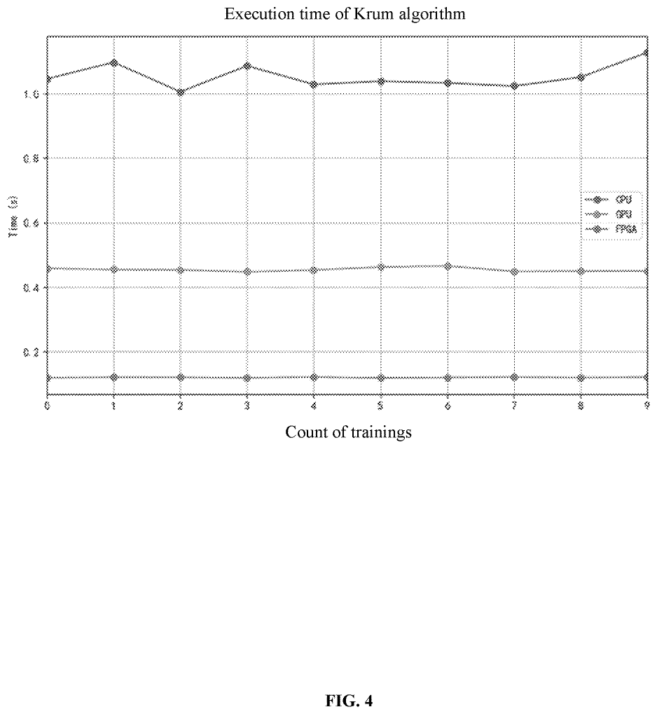

FIG. 4 is a schematic diagram illustrating a comparison of performance of a Krum algorithm according to some embodiments of the present disclosure. Experimental results in FIG. 4 show that a CPU execution time is above 1 second, and stability of the CPU execution time is poor. A GPU execution time is about 0.44 seconds. The GPU execution time is about 2.27 times faster than the CPU execution time, and stability of the GPU execution time is good. An FPGA execution time is about 0.12 seconds. The FPGA execution time is about 8.33 times faster than the CPU execution time. The FPGA execution time is about 3.67 times faster than the GPU execution time. Stability of the FPGA execution time is the best. However, operation on the FPGA involves floating-point to fixed-point conversion. For the experiment, a gradient conversion time does not exceed 0.18 seconds. Even including the conversion time, the FPGA execution time is still more efficient than the CPU execution time and the GPU execution time. Therefore, compared with the CPU and the GPU, the FPGA also demonstrates excellent performance in terms of scalability and flexibility. The FPGA can significantly improve the execution efficiency of the Krum algorithm.

It should be understood that the system and the modules shown in FIG. 1 may be implemented in various ways.

It should be noted that the above descriptions of the system for hardware acceleration and optimization of the Krum algorithm in federated learning and the modules thereof are provided for the purposes of illustration, and are not intended to limit the scope of the present disclosure. It is understood that for persons skilled in the art, after understanding the principle of the system, it may be possible to arbitrarily combine individual modules or form a subsystem to connect with other modules without deviating from this principle. In some embodiments, the data control module, the data FIFO module, and the algorithm computing module disclosed in FIG. 1 may be different modules in a single system, or may be a single module that implements the functions of two or more of the aforementioned modules. For example, the individual modules may share a common storage module, and the individual modules may each have their own storage module. Variations such as these are within the scope of protection of the present disclosure.

The embodiments of the present disclosure provide a method for hardware acceleration and optimization of a Krum algorithm in federated learning. In some embodiments, the method for hardware acceleration and optimization of a Krum algorithm in federated learning may be executed by the system for hardware acceleration and optimization of a Krum algorithm in federated learning.

In some embodiments, the method for hardware acceleration and optimization of a Krum algorithm in federated learning includes: controlling a data pipelined operation: implementing pipelined control of data through an FSM; caching data of a participant and reading the data of the participant multiple times; performing Krum algorithm computation by reading a parameter from an FIFO buffer and a parameter of another participant from a memory, including: first performing an addition operation and a multiplication operation for calculating a Euclidean distance between gradients of two participants; then performing a square root operation on an output sum of squares result to obtain a true Euclidean distance between the two participants; finally selecting smallest n−f−1 valid values from Euclidean distances calculated from a plurality of participants, summing the selected smallest n−f−1 valid values to calculate a valid distance sum, and feeding back the valid distance sum to a front end.

More descriptions regarding the method for hardware acceleration and optimization of the Krum algorithm in federated learning may be found in FIG. 1 and the related descriptions thereof.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of the present disclosure.

Moreover, certain terminology has been used to describe embodiments of the present disclosure. For example, the terms “one embodiment,” “an embodiment,” and “some embodiments” mean that a particular feature, structure, or feature described in connection with the embodiment is included in at least one embodiment of the present disclosure. Therefore, it is emphasized and should be appreciated that two or more references to “an embodiment” or “one embodiment” or “an alternative embodiment” in various portions of the present disclosure are not necessarily all referring to the same embodiment. Furthermore, the particular features, structures, or features may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for description purpose and that the appended claims are not limited to the disclosed embodiments, but, on the contrary, are intended to cover modifications and equivalent arrangements that are within the spirit and scope of the disclosed embodiments. For example, although the implementation of various parts described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, numbers describing the number of ingredients and attributes are used. It should be understood that such numbers used for the description of the embodiments use the modifier “about”, “approximately”, or “substantially” in some examples. Unless otherwise stated, “about”, “approximately”, or “substantially” indicates that the number is allowed to vary by ±20%. Correspondingly, in some embodiments, the numerical parameters used in the description and claims are approximate values, and the approximate values may be changed according to the required features of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

1. A system for hardware acceleration and optimization of a Krum algorithm in federated learning, comprising a data control module, a data First In First Out (FIFO) module, and an algorithm computing module, wherein the data control module, the data FIFO module, and the algorithm computing module are sequentially connected, and the data control module is connected to the algorithm computing module;
the data control module is configured to perform pipeline control of the Krum algorithm; the data FIFO module is configured to cache a model gradient parameter of a client and perform cyclic reading; and the algorithm computing module is configured to compute the Krum algorithm, including Euclidean distance calculation and minimum gradient calculation;
the data control module is configured for orderly pipeline control of data and supports backpressure calculation;
the orderly pipeline control of data is implemented by a finite state machine (FSM);
a state transition condition is dynamically adjusted according to an input data volume (in_sum) and a count of arithmetic logic units (ALU_MEM);
each state includes a pipeline pressure enable (ppen) signal trigger condition for controlling data flow and backpressure; and
after receiving a start signal (start), the data control module drives a transition of a processing stage of data through the FSM, and precisely tracks progress of the data in a plurality of processing stages through a counter; the data control module generates, according to a current processing stage of the data, a ppen signal and transmits the ppen signal to the algorithm computing module to control orderly flow of the data among buffering, processing, and clearing stages, thereby achieving efficient data transmission.

2. The system according to claim 1, wherein the data control module implements pipelined control of data through the FSM;
the FSM includes seven states: an idle state (IDLE), a first buffering state (BUFFING) and a second buffering state (BUFFING1), a first pipeline processing state (PIPEING) and a second pipeline processing state (PIPEING1), a first clearing state (CLRING) and a second clearing state (CLRING1);
when the in_sum is not greater than the ALU_MEM, the FSM enters the BUFFING1, the PIPEING1, and the CLRING1; otherwise, the FSM enters the BUFFING, the PIPEING, and the CLRING; and
each state determines three output signals, which are the ppen signal, an in_ready signal, and an out_valid signal; the ppen signal indicates whether to compute current data, and whether to enter the algorithm computing module; the in_ready signal indicates whether data still exists in the algorithm computing module, and whether data in the algorithm computing module is being computed or whether data has been computed but has not been transmitted to a next module for continued computation; and the out_valid signal indicates whether there is data output.

3. The system according to claim 2, wherein the when the in_sum is not greater than the ALU_MEM, the FSM enters the BUFFING1, the PIPEING1, and the CLRING1; otherwise, the FSM enters the BUFFING, the PIPEING, and the CLRING includes:
generating a gate switching signal according to the in_sum and the ALU_MEM, and sending the gate switching signal to a first multiplexer, wherein the gate switching signal controls the first multiplexer to connect a gate terminal to a direct input, or to switch the gate terminal to an FIFO output port.

4. The system according to claim 2, wherein the data control module is configured to:
in response to the FSM entering the BUFFING, the PIPEING, and the CLRING, determine, at intervals of a first cycle, whether to perform path switching according to a remaining data volume and the ALU_MEM; and
in response to a determination result being to perform path switching, switch the FSM to the BUFFING1, the PIPEING1, and the CLRING1.

5. The system according to claim 4, wherein the data control module is configured to:
after switching the FSM to the BUFFING1, the PIPEING1, and the CLRING1, in response to a backpressure frequency being less than a first backpressure threshold, inject a reset signal into the counter through a second multiplexer at a terminal clock edge of the PIPEING1.

6. The system according to claim 1, wherein the data control module further includes two input signals: an in_valid signal and an out_ready signal; wherein the in_valid signal indicates whether there is data waiting for computation and is a data input flag, and the out_ready signal indicates whether a backend receives data and is a backpressure signal flag;
after receiving the start, the data control module selects to first enter a buffering state according to a magnitude relationship between the in_sum and the ALU_MEM, comprising: if the in_sum is less than or equal to the ALU_MEM, entering the BUFFING1, otherwise, entering the BUFFING;
if it is detected that there is data input waiting for computation, and the in_valid signal is at a high level, the data control module adjusts output signals including the ppen signal, the in_ready signal, and the out_valid signal according to a current state; and
when data stored in the buffering state equals the ALU_MEM and there is still data input waiting for computation, and the in_valid signal remains at the high level, the data control module switches to the PIPEING or the PIPEING1, and the output signals change again with the current state; when there is no new data input waiting for computation and the in_valid signal is at a low level, and only cached data remains, the data control module enters the CLRING or the CLRING1, and the output signals including the ppen signal, the in_ready signal, and the out_valid signal are adjusted according to a clearing state.

7. The system according to claim 1, wherein the data FIFO module is an FIFO buffer supporting multiple readouts;
the FIFO buffer is configured to cache the model gradient parameter of the client and complete calculation of a model score of the client through repeated reading, comprising:
assuming a count of clients is cₙ, if a score of a model gradient of a client cᵢ is to be calculated, caching a model gradient gᵢ of the client cᵢ in the FIFO buffer, and repeatedly reading the model gradient gᵢ to calculate a Euclidean distance between the model gradient gᵢ and model gradients corresponding to other clients;
controlling a count of readouts through the counter, and after the model gradient gᵢ is read n−1 times, caching a model gradient gᵢ₊₁ until an algorithm operation ends; wherein
in the data FIFO module, data caching and computation are performed simultaneously without waiting for the model gradient gᵢ of the client cᵢ to be completely cached, allowing Euclidean distance calculation with model gradients of other clients after caching a first gradient parameter; the data FIFO module further includes a read enable signal (rd_allow) and a write enable signal (wr_allow); when a write enable is high and the FIFO buffer is not full, the wr_allow is at a high level, and data is written into the data FIFO module; and when a read enable is high and the FIFO buffer is not empty, data is read out.

8. The system according to claim 7, wherein the controlling a count of readouts through the counter, and after the model gradient gᵢ is read n−1 times, caching a model gradient gᵢ₊₁ until an algorithm operation ends includes:
in response to the count of readouts being less than n−1, generating a pointer reset signal, wherein the pointer reset signal controls the data FIFO module to reset a read pointer of a memory array to a starting address of the model gradient gᵢ.

9. The system according to claim 7, wherein the data FIFO module is further configured to:
when repeatedly reading the model gradient gᵢ, in response to the count of readouts being greater than a preset readout threshold, cache header data of the model gradient gᵢ₊₁.

10. The system according to claim 9, wherein the data FIFO module is further configured to:
at intervals of a second cycle, adjust the preset readout threshold according to a current data dimensional feature and a backpressure frequency.

11. The system according to claim 9, wherein the data FIFO module is further configured to:
in response to a backpressure frequency being greater than a second backpressure threshold, before caching the header data, control the memory array to stop caching during a preset protection period.

12. The system according to claim 1, wherein the algorithm computing module includes an accumulation module, a square root module, and a minimum gradient calculation module;
the accumulation module is configured to perform an addition operation and a multiplication operation for calculating a Euclidean distance between gradients of two participants;
the square root module is configured to perform a square root operation on a sum of squares result output by the accumulation module to obtain a true Euclidean distance between the two participants; and
the minimum gradient calculation module is configured to select smallest n−f−1 valid values from Euclidean distances calculated from a plurality of participants, sum the selected smallest n−f−1 valid values to calculate a valid distance sum, and use the valid distance sum as a basis for model update.

13. The system according to claim 12, wherein the accumulation module is configured to perform an addition operation and a multiplication operation for calculating a Euclidean distance between gradients of two participants, including:
the accumulation module implementing start control and data flow synchronization management of a computation process through the ppen signal generated by the data control module, comprising: when the ppen signal is valid, first generating an absolute difference of two pieces of input data, and obtaining a square of the absolute difference through a square operation; and performing point-by-point accumulation on the two pieces of input data until the counter reaches a set count of neurons, and outputting an accumulation result.

14. The system according to claim 1, wherein a delayed clocking operation is performed via delay_ppen.

15. The system according to claim 1, wherein in a minimum gradient calculation module, first Euclidean distance data calculated by each participant is received and stored in a register; then a parallel comparison mechanism is adopted to quickly compare the Euclidean distance data in a storage area, and smallest n−f−1 valid distances are selected from the Euclidean distance data; and finally the selected smallest n−f−1 valid distances are summed to calculate a total valid distance, and the total valid distance is fed back to a front end.

16. A method for hardware acceleration and optimization of a Krum algorithm in federated learning, comprising:
controlling a data pipelined operation, comprising implementing pipelined control of data through an FSM;
caching data of a participant and reading the data of the participant multiple times;
performing Krum algorithm computation by reading a parameter from an FIFO buffer and a parameter of another participant from a memory, comprising: first performing an addition operation and a multiplication operation for calculating a Euclidean distance between gradients of two participants; then performing a square root operation on an output sum of squares result to obtain a true Euclidean distance between the two participants; finally selecting smallest n−f−1 valid values from Euclidean distances calculated from a plurality of participants, summing the selected smallest n−f−1 valid values to calculate a valid distance sum, and feeding back the valid distance sum to a front end;
dynamically adjusting a state transition condition according to an in_sum and an ALU_MEM;
providing a ppen signal trigger condition in each state for controlling data flow and backpressure; and
after receiving a start, driving, by the FSM, a transition of a processing stage of data, and precisely tracking progress of the data in a plurality of processing stages through a counter; and generating a ppen signal and transmitting the ppen signal to an algorithm computing module according to a current processing stage of the data to control orderly flow of the data among buffering, processing, and clearing stages, thereby achieving efficient data transmission.
